(19) United States
(12) Patent Application Publication
(10) Pub. No.: US 2014/0074954 A1
(43) Pub. Date: Mar. 13, 2014

(54) Method, system and device for implementing reposting to microblog

(71) Applicant: TENCENT TECHNOLOGY (SHENZHEN) COMPANY LIMITED, Shenzhen (CN)

(72) Inventors: Weijian Jin, Shenzhen (CN); Jian Li, Shenzhen (CN); Maolin Chen, Shenzhen (CN); Xiaobin Sun, Shenzhen (CN); Lei Wei, Shenzhen (CN)

(21) Appl. No.: 14/078,355

(22) Filed: Nov. 12, 2013

Related U.S. Application Data
(63) Continuation of application No. PCT/CN2012/079289, filed on Jul. 27, 2012.

(30) Foreign Application Priority Data
Sep. 13, 2011 (CN) 201110268918.0

(51) Int. Cl. H04L 12/58

(52) U.S. Cl. CPC H04L 51/00
USPC 709/206

(57) ABSTRACT

The disclosure discloses a method for implementing reposting to a microblog, which includes: a microblog webpage server transmits information of a microblog user, who posts a microblog message, to a webpage server of a webpage after posting the microblog message including information of the webpage; and the webpage server updates a microblog page link of a microblog user that has performed reposting on the webpage to a microblog page link of the microblog user according to the information of the microblog user. The disclosure further discloses a system and devices for implementing reposting to a microblog, which facilitates popularization of microblog pages of users and can enhance attention of the microblog users, thereby promoting user experience, perfecting a function of reposting to a microblog, increasing a resource sharing efficiency for webpages and improving resource utilization.

### CROSS REFERENCE TO RELATED APPLICATIONS

This is a continuation application of International Patent Application No.: PCT/CN2012/079289, filed on Jul. 27, 2012, which claims priority to Chinese Patent Application No.: 201110268918.0, filed on Sep. 13, 2011, the disclosure of which is incorporated by reference herein in its entirety.

### TECHNICAL FIELD

The disclosure relates to a webpage development technology, and in particular to a method, a system and devices for implementing reposting to a microblog.

### BACKGROUND

A microblog is a widely used micro blog at present. A function of the microblog of reposting to a microblog is to provide a third party sharing interface, which connects a microblog webpage server with a third party server and can introduce third party resources (such as webpages) into microblog messages posted by users to facilitate sharing among the users. Specifically, for a news page, the function of reposting to a microblog is generally to display a link to the news page in a microblog message posted by a user, and other users can access the news page by the link, which not only facilitates sharing news information among the users, but also facilitates propagation of news.

However, based on the function of reposting to a microblog above, only resources of a third party can be displayed in a microblog message of a user, and the user can be guided to obtain the resources of the third party; since related information of the microblog user is not displayed in the resources of the third party, the function of reposting to a microblog is imperfect, resources cannot be used effectively and user experience is also influenced.

### SUMMARY

In view of the above problem, the main purpose of the disclosure is to provide a method, a system and devices for implementing reposting to a microblog, which can perfect the function of reposting to a microblog and improve resource utilization.

In order to achieve the above purpose, the technical solution of the disclosure is as follows.

The disclosure provides a method for implementing reposting to a microblog, which includes:

a microblog webpage server transmits information of a microblog user, who posts a microblog message, to a webpage server of a webpage after posting the microblog message including information of the webpage; and

the webpage server updates a microblog page link of a microblog user that has performed reposting on the webpage to a microblog page link of the microblog user according to the information of the microblog user.

The disclosure further provides a microblog webpage server, which is configured to transmit information of a microblog user, who posts a microblog message, to a webpage server of a webpage after posting the microblog message including information of the webpage.

The disclosure further provides a webpage server, which is configured to update a microblog page link of a microblog user that has performed reposting on a webpage to a microblog page link of a microblog user according to information of the microblog user transmitted by a microblog webpage server.

The disclosure further provides a system for implementing reposting to a microblog, which includes a microblog webpage server and a webpage server, wherein

the microblog webpage server is configured to transmit information of a microblog user, who posts a microblog message, to the webpage server after posting the microblog message including information of the webpage; and

the webpage server is configured to update a microblog page link of a microblog user that has performed reposting on the webpage to a microblog page link of the microblog user according to the information of the microblog user transmitted by the microblog webpage server.

In the method, the system and the devices for implementing reposting to a microblog according to the disclosure, after a microblog webpage server posts a microblog message including information of a webpage, a webpage server obtains information of a microblog user from the microblog webpage server, and displays a microblog page link of the microblog user that has performed reposted on the webpage, which facilitates popularization of microblog pages of users and can enhance attention to the microblog users, thereby promoting user experience, increasing the resource sharing efficiency for webpages, improving resource utilization and perfecting the function of reposting to a microblog.

### BRIEF DESCRIPTION OF THE DRAWINGS

FIG. 1 shows a flowchart of a method for implementing reposting to a microblog according to the disclosure;

FIG. 2 shows a detailed flowchart of implementing a process of reposting to a microblog according to embodiment 1 of the disclosure; and

FIG. 3 shows a schematic diagram of a part of a news webpage after updating information of a microblog user that has performed reposting according to embodiment 1 of the disclosure.

### DETAILED DESCRIPTION

The basic idea of the disclosure is: after a webpage is reposted to a microblog, information related to a microblog user that reposts the webpage, such as a microblog page link of the microblog user and the like, is displayed on the webpage, which facilitates popularization of microblog pages of the user and can enhance attention to the microblog user, thereby promoting user experience, increasing a resource sharing efficiency for webpages, improving resource utilization and perfecting the function of reposting to a microblog.

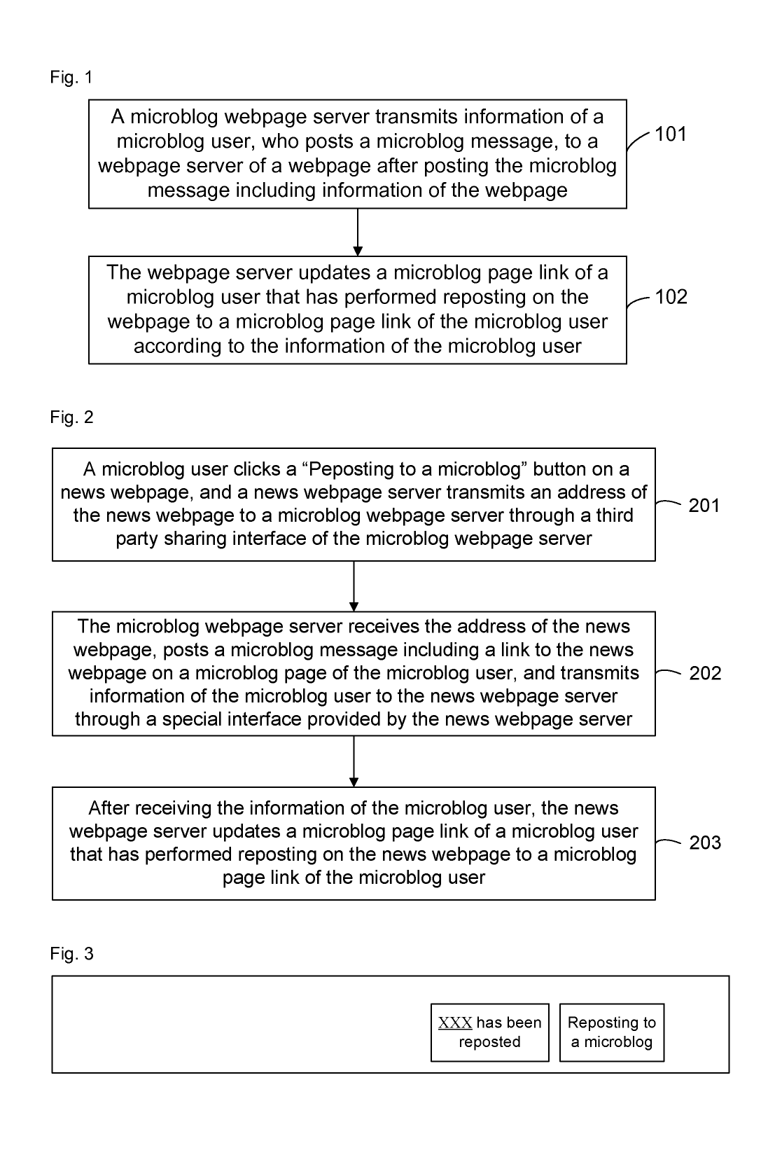

Referring to FIG. 1, a method for implementing reposting to a microblog according to the disclosure may mainly include the following steps:

Step 101: a microblog webpage server transmits information of a microblog user, who posts a microblog message, to a webpage server of a webpage after posting the microblog message including information of the webpage; and

Step 102: the webpage server updates a microblog page link of a microblog user that has performed reposting on the webpage to a microblog page link of the microblog user according to the information of the microblog user.

Wherein the webpage may be a webpage containing any other contents, and the webpage server is a webpage server configured to provide the webpage for a user. For example, the webpage may be a news webpage, and the webpage server may be a news webpage server, correspondingly.

Correspondingly, the disclosure further provides a microblog webpage server for implementing reposting to a microblog, which is configured to transmit information of a microblog user, who posts a microblog message, to a webpage server of a webpage after posting the microblog message including information of the webpage.

The disclosure further provides a webpage server for implementing reposting to a microblog, which is configured to update a microblog page link of a microblog user that has performed reposting on a webpage to a microblog page link of a microblog user according to information of the microblog user transmitted by a microblog webpage server.

Furthermore, the disclosure further provides a system for implementing reposting to a microblog, which may include the above microblog webpage server and the above webpage server.

Wherein the webpage server is further configured to provide a special interface used for transmitting the information of the microblog user; and the microblog webpage server is further configured to transmit the information of the microblog user to the webpage server through the special interface provided by the webpage server.

Wherein the webpage server is further configured to transmit the information of the webpage to the microblog webpage server through a third party sharing interface provided by the microblog webpage server; and

the microblog webpage server is further configured to provide the third party sharing interface used for transmitting the information of the webpage; and generate a microblog message including a link to the webpage according to the information of the webpage transmitted by the webpage server, and post the microblog message on the microblog page of the microblog user.

Embodiment 1

In this embodiment, a detailed process of implementing reposting to a microblog is illustrated by taking a news webpage as an example.

As shown in FIG. 2, the detailed process of implementing reposting to a microblog may include:

Step 201: a microblog user clicks a “Reposting to a microblog” button on a news webpage, and a news webpage server transmits an address of the news webpage to a microblog webpage server through a third party sharing interface of the microblog webpage server;

Step 202: the microblog webpage server receives the address of the news webpage, posts a microblog message including a link to the news webpage on a microblog page of the microblog user, and transmits information of the microblog user to the news webpage server through a special interface provided by the news webpage server;

specifically, the microblog webpage server receives the address of the news webpage to generate a microblog message including a link to the news webpage, posts the microblog message on the microblog page of the microblog user, and transmits the information of the microblog user to the news webpage server through the special interface provided by the news webpage server;

wherein the information of the microblog user may include a user name of the microblog user, a microblog page address of the microblog user and the like;

here, the news webpage server may provide one special interface used for obtaining the information of the microblog user and reach an agreement with the microblog webpage server in advance, and then the microblog webpage server can transmit the information of the microblog user to the news webpage server through the special interface; and

Step 203: after receiving the information of the microblog user, the news webpage server updates a microblog page link of a microblog user that has performed reposting on the news webpage to a microblog page link of the microblog user; in this way, when a user browses a news webpage, the user can know from the news webpage the microblog user that has reposted the link to the news webpage via the microblog message, and can access the microblog page of the microblog user according to information of the microblog user, so that the user can go to the related microblog page from the news webpage;

specifically, if a news webpage currently does not display any microblog page link of a microblog user that has performed reposting, then a link to the microblog page of the microblog user can be created directly according to the obtained information of the microblog user, and is added on the news webpage;

wherein the link to the microblog page of the microblog user may be a link that uses the user name of the microblog user as a link name or a link that uses the microblog page address of the microblog user as a link address.

In an actual application, in order to facilitate users' operations, the link to the microblog page of the microblog user can be displayed beside the “Reposting to a microblog” button on a news webpage. For example, as shown in FIG. 2, information “XXX has been reposted” is displayed beside the “Reposting to a microblog” button within a designated area on the news webpage, wherein “XXX” is a user name of a microblog user, which is set as a hyperlink that can be linked to a microblog page of the microblog user, and a user can go to the microblog page of the microblog user by clicking “XXX”.

The above is only a preferable embodiment of the disclosure, and is not intended to limit the scope of protection of the disclosure.

1. A method for implementing reposting to a microblog, comprising:
transmitting, by a microblog webpage server, information of a microblog user, who posts a microblog message, to a webpage server of a webpage after posting the microblog message including information of the webpage; and
updating, by the webpage server, a microblog page link of a microblog user that has performed reposting on the webpage to a microblog page link of the microblog user according to the information of the microblog user.

2. The method for implementing reposting to a microblog according to claim 1, wherein
the information of the microblog user comprises a user name of the microblog user and a microblog page address of the microblog user; and
the microblog page link of the microblog user is a link that uses the user name of the microblog user as a link name, or a link that uses the microblog page address of the microblog user as a link address.

3. The method for implementing reposting to a microblog according to claim 1, wherein the transmitting, by a microblog webpage server, information of a microblog user, who posts a microblog message, to a webpage server of a webpage comprises:
transmitting, by the microblog webpage server, the information of the microblog user to the webpage server through a special interface provided by the webpage server.

4. The method for implementing reposting to a microblog according to claim 1, wherein the posting the microblog message including information of the webpage comprises:
transmitting, by the webpage server, an address of the webpage to the microblog webpage server through a third party sharing interface provided by the microblog webpage server; and
generating, by the microblog webpage server, a microblog message including a link to the webpage according to the information of the webpage, and posting the microblog message on a microblog page of the microblog user.

5. The method for implementing reposting to a microblog according to claim 1, wherein the webpage is a news webpage.

6. A microblog webpage server, being configured to transmit information of a microblog user, who posts a microblog message, to a webpage server of a webpage after posting the microblog message including information of the webpage.

7. A webpage server, being configured to update a microblog page link of a microblog user that has performed reposting on a webpage to a microblog page link of a microblog user according to information of the microblog user transmitted by a microblog webpage server.

8. A system for implementing reposting to a microblog, comprising a microblog webpage server and a webpage server, wherein
the microblog webpage server is configured to transmit information of a microblog user, who posts a microblog message, to the webpage server after posting the microblog message including information of the webpage; and
the webpage server is configured to update a microblog page link of a microblog user that has performed reposting on the webpage to a microblog page link of the microblog user according to the information of the microblog user transmitted by the microblog webpage server.

9. The system for implementing reposting to a microblog according to claim 8, wherein
the webpage server is further configured to provide a special interface used for transmitting the information of the microblog user; and
the microblog webpage server is further configured to transmit the information of the microblog user to the webpage server through the special interface provided by the webpage server.

10. The system for implementing reposting to a microblog according to claim 8, wherein
the webpage server is further configured to transmit the information of the webpage to the microblog webpage server through a third party sharing interface provided by the microblog webpage server; and
the microblog webpage server is further configured to provide the third party sharing interface used for transmitting the information of the webpage, to generate a microblog message including a link to the webpage according to the information of the webpage transmitted by the webpage server, and to post the microblog message on a microblog page of the microblog user.

11. The system for implementing reposting to a microblog according to claim 8, wherein the webpage server is a news webpage server.

12. The method for implementing reposting to a microblog according to claim 2 wherein the webpage is a news webpage.

13. The method for implementing reposting to a microblog according to claim 3, wherein the webpage is a news webpage.

14. The method for implementing reposting to a microblog according to claim 4, wherein the webpage is a news webpage.

15. The system for implementing reposting to a microblog according to claim 9, wherein the webpage server is a news webpage server.

16. The system for implementing reposting to a microblog according to claim 10, wherein the webpage server is a news webpage server.
